(19) United States
(12) Patent Application Publication
(10) Pub. No.: US 2026/0018151 A1
(43) Pub. Date: Jan. 15, 2026

(54) Noise Abatement System for Ground-Borne Noise in Marine Environment

(71) Applicant: AdBm Corp., Austin, TX (US)

(72) Inventors: Mark S. Wochner, Pittsford, NY (US); Andrew McNeese, Austin, TX (US); Preston S. Wilson, Austin, TX (US); Kevin M. Lee, Austin, TX (US)

(21) Appl. No.: 19/266,566

(22) Filed: Jul. 11, 2025

Related U.S. Application Data
(60) Provisional application No. 63/670,255, filed on Jul. 12, 2024.
(60) Provisional application No. 63/748,067, filed on Jan. 22, 2025.
(60) Provisional application No. 63/764,277, filed on Feb. 27, 2025.

(51) Int. Cl. G10K 11/00

(52) U.S. Cl. CPC G10K 11/002

(57) ABSTRACT

A noise abatement system includes a support body having a hole configured to receive a monopile; and a plurality of resonators attached to a bottom surface of the support body, each resonator having a tapered tip that is configured to mechanically engage a floor of a body of water so as to acoustically couple a respective resonator and the floor of the body of water, the bottom surface oriented towards a direction of gravitational pull. Additional resonators can be mechanically coupled to a pile gripper, a pile template, or other framework equipment in one or more embodiments.

### CROSS-REFERENCE TO RELATED APPLICATIONS

This application claims priority to U.S. Provisional Application No. 63/670,255, titled “Noise Abatement System for Ground-Borne Noise in Marine Environment,” filed on Jul. 12, 2024, to U.S. Provisional Application No. 63/748,067, titled “Noise Abatement System for Marine Environment,” filed on Jan. 22, 2025, and to U.S. Provisional Application No. 63/764,277, titled “Slot Resonators for Underwater Noise Abatement,” filed on Feb. 27, 2025, which are hereby incorporated by reference.

### TECHNICAL FIELD

This application relates generally to underwater noise abatement.

### BACKGROUND

Underwater noise is created due to human activities such as drilling, pile driving, and underwater explosives. This noise can be harmful to marine animals, and governments have established limits on the underwater noise created through such activities.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a noise abatement system comprising a support body having a hole configured to receive a monopile; and a plurality of resonators attached to a bottom surface of the support body, each resonator having a tapered tip that is configured to mechanically engage a floor of a body of water so as to acoustically couple a respective resonator and the floor of the body of water, the bottom surface oriented towards a direction of gravitational pull.

In one or more embodiments, each resonator includes a respective cavity configured to retain a gas. In one or more embodiments, the noise abatement system further comprises a gas source; and a plurality gas lines, each gas line fluidly coupled to the gas source and to the respective cavity(ies) of one or more of the resonators. In one or more embodiments, each resonator has a solid body.

In one or more embodiments, the resonators are first resonators and the noise abatement system further comprises a plurality of second resonators mechanically coupled to a support structure, the support structure mechanically coupled to or disposed within about 100 meters of the monopile. In one or more embodiments, the noise abatement system further comprises a spool mechanically coupled to the support structure; and one more tethers attached to the spool, the tether(s) mechanically coupled to the second resonators, wherein the spool has a stowed state in which the tether(s) is/are wound around the spool and a deployed state in which the tether(s) is/are at least partially unwound from the spool. In one or more embodiments, the second resonators are formed in resonator blocks, the resonator blocks mechanically coupled to the tether(s). In one or more embodiments, each resonator block has a plurality of closed surfaces and a bottom surface in which one or more holes is/are defined, the hole(s) fluidly coupled to one or more resonator cavities defined in a body of a respective resonator block, each hole having a respective length, as measured with respect to a first axis, that is greater than a respective width, as measured with respect to a second axis, the bottom surface oriented orthogonally a third axis and towards the direction of gravitational pull, the first, second, and third axes mutually orthogonal. In one or more embodiments, the respective width is about 2 times to about 100 times greater than the respective width.

In one or more embodiments, each resonator block has a base and a plurality of walls that extend from the base, the walls and the base comprising closed surfaces that define one or more resonator cavities, each resonator cavity having a respective open end disposed away from the base relative to a third axis, and each resonator cavity has a respective length, as measured with respect to a first axis, that is greater than a respective width, as measured with respect to a second axis, the respective open end oriented orthogonally to the third axis and towards the direction of gravitational pull, the first, second, and third axes mutually orthogonal. In one or more embodiments, each resonator block defines a plurality of the resonator cavities, the resonator cavities arranged in one or more rows. In one or more embodiments, each resonator cavity has a respective volume, and a volume of at least one of the resonator cavities is different than the volume of one or more other resonator cavities in a respective resonator block.

In one or more embodiments, each resonator block has a base and a plurality of hollow resonator bodies that extend from the base, each hollow resonator body has a respective closed end that is disposed away from the base relative to an axis, and a plurality of holes are defined in the base, each hole spatially aligned with and fluidly coupled a respective resonator cavity, the respective hole oriented towards the direction of gravitational pull, the direction of gravitation pull parallel to the axis.

In one or more embodiments, the axis is a first axis, the resonator cavities form at least one row, each row extending parallel to a second axis, at least some of the resonator cavities in a respective row are spatially offset from one or more other resonator cavities in the respective row with respect to a third axis, and the first, second, and third axes are mutually orthogonal. In one or more embodiments, the resonator cavities form at least one column, each column extending parallel to the third axis, and at least some of the resonator cavities in a respective column are spatially offset from one or more other resonator cavities in the respective column with respect to the second axis.

In one or more embodiments, the support body comprises a plurality of concentric hollow cylinders that define rings, and the noise abatement system further comprises a plurality of crossbars attached to the concentric hollow cylinders, each crossbar extending radially across the concentric hollow cylinders; and a plurality of tethers, each tether mechanically coupled to one or more of the concentric hollow cylinders to raise and lower the concentric hollow cylinders.

Another aspect of the invention is directed to a noise abatement system comprising a support body having a hole configured to receive a support structure, the support structure mechanically coupled to or disposed within about 100 meters of a monopile; a plurality of arms, each arm having an end attached to the support body, each arm extending radially from the support body; and a plurality of resonators attached to a bottom surface of each arm, each resonator having a tapered tip that is configured to mechanically engage a floor of a body of water so as to acoustically couple a respective resonator and the floor of the body of water, the bottom surface of each arm oriented towards a direction of gravitational pull.

In one or more embodiments, the end is a first end, the first end of each arm is pivotably attached to the support body such that the arms can transition from a stowed state in which a second end of each arm is closer to the monopile than when the arms are in a deployed state in which the second end of each arm is further from the monopile than when the arms are in the stowed state, and the noise abatement system further comprises a plurality of tethers, each tether mechanically coupled to one or more of the arms to transition the one or more of the arms between the stowed and deployed states.

Another aspect of the invention is directed to a noise abatement system comprising a common support body having a hole configured to receive a support structure, the support structure mechanically coupled to or disposed within about 100 meters of a monopile; a plurality of resonator support bodies, each resonator support body mechanically coupled to the common support body; and a plurality of resonators attached to a bottom surface of resonator support body, each resonator having a tapered tip that is configured to mechanically engage a floor of a body of water so as to acoustically couple a respective resonator and the floor of the body of water, the bottom surface oriented towards a direction of gravitational pull.

In one or more embodiments, the noise abatement system further comprises a plurality of support arms, each support arm attached to the common support body and to a respective resonator support body.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is an isometric view of a noise-abatement system for ground-borne noise in a deployed state according to one or more embodiments.

FIG. 2 is an isometric view of the noise-abatement system shown in FIG. 1 in retracted state according to one or more embodiments.

FIGS. 3A-3C are bottom views of a support body according to one or more alternative embodiments.

FIG. 4 is an isometric view of a noise-abatement system for water and ground-borne noise according to one or more embodiments.

FIG. 5A is an isometric view of a noise abatement system for water and ground-borne noise in a deployed state according to one or more alternative embodiments.

FIG. 5B is an isometric view of the noise-abatement system shown in FIG. 5A in a partially stowed state according to one or more embodiments.

FIG. 5C is an isometric view of the noise-abatement system shown in FIG. 5A in a stowed state according to one or more embodiments.

FIG. 6 is a top view of a noise abatement system for water- and ground-borne noise according to one or more alternative embodiments.

FIG. 7 is a bottom view of a noise abatement system for water- and ground-borne noise according to one or more alternative embodiments.

FIG. 8 is an isometric view of a noise abatement system for ground-borne noise according to one or more alternative embodiments.

FIG. 9 is an isometric view of a noise abatement system for ground-borne noise according to one or more alternative embodiments.

FIG. 10A is an isometric view of a noise abatement system for water- and ground-borne noise in a deployed state according to one or more alternative embodiments.

FIG. 10B is an isometric view of the noise abatement system shown in FIG. 10A in a stowed state according to one or more alternative embodiments.

FIGS. 11A and 11B are isometric views of resonators blocks according to one or more alternative embodiments.

FIGS. 12-14 are isometric views of resonator blocks according to one or embodiments.

FIGS. 15A and 15B are isometric bottom and top views, respectively, of a resonator block according to one or more embodiments.

FIGS. 16A and 16B are isometric bottom and top views, respectively, of a resonator block according to one or more embodiments.

FIGS. 17A and 17B are isometric bottom and top views, respectively, of a resonator block according to one or more embodiments.

FIGS. 18A and 18B are isometric bottom and top views, respectively, of a resonator block according to one or more embodiments.

### DETAILED DESCRIPTION

A noise-abatement system includes one or more support bodies that is/are mechanically coupled to a monopile or to a structure such as a pile gripper, a pile template, or any other piece of framework equipment to support the installation of monopiles. Resonators are attached to a bottom surface of each support body which is oriented in the direction of gravitational pull and towards the seafloor (or towards the floor of another body of water). The resonators have a tapered and/or pointed tip that is configured to mechanically engage the seafloor to improve acoustical communication and/or acoustical coupling between the seafloor and the resonators, for example to mitigate ground-borne noise.

Additional resonators can be attached and/or mechanically coupled to the support body (ies), a pile gripper, and/or a pile template, for example to mitigate water-borne noise. The additional resonators can include resonator blocks that can be mechanically coupled to each other. The resonator blocks can be mechanically coupled to a tether that can be used to deploy and/or stow the resonator blocks. In one or more embodiments, the resonator blocks can include slot resonators. In one or more embodiments, the slot resonators can be formed in a resonator body having closed surfaces except for one or more resonator cavities defined in the resonator body that are exposed with respective hole(s) in one of the surfaces. In one or more embodiments, the slot resonators can be formed in a base and a plurality of walls that extend from the base to form the resonator cavity(ies). In one or more embodiments, a resonator block includes a base and a plurality of hollow resonator bodies that extend from the base. A plurality of holes are defined in the base to expose respective resonator cavities defined in the hollow resonator bodies.

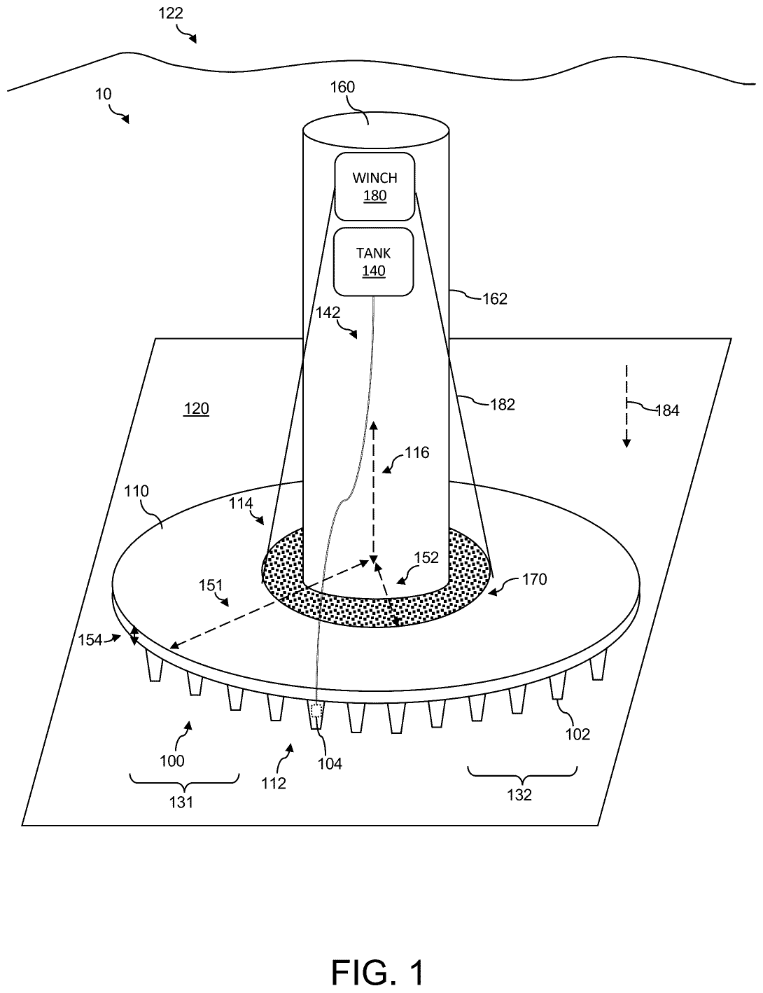

FIG. 1 is an isometric view of a noise-abatement system 10 for ground-borne noise according to one or more embodiments. The noise-abatement system 10 includes a plurality of resonators 100 attached to a bottom surface 112 of a support body 110. The system 10 is shown in a deployed state. The system 10 and/or the support body 110 is/are shown in a deployed state.

The resonators 100 are configured to contact the seafloor. Each resonator 100 has a tapered and/or pointed end (in general, tapered) 102 that is configured to mechanically contact the floor 120 of a body of water 122. The floor 120 represents the ground at the bottom of the body of water 122. For example, the floor 120 can be a seafloor (in which case the body of water 122 is a sea), an ocean floor (in which case the body of water 122 is an ocean), or a lake floor (in which case the body of water 122 is a lake).

In one or more embodiments, the tapered end 102 is configured to dig into the floor 120. Mechanical contact and/or mechanical coupling of the tapered ends 102 of some or all of the resonators 100 and the floor 120 provides acoustical coupling between the floor 120 and the resonators 100 to allow acoustical energy from the floor 120, such as in ground-borne noise, to pass into the resonators 100 for abatement and/or mitigation.

The resonators 100 can be arranged into arrays, groups, rows, concentric circles/rings, and/or other arrangements and/or configurations. The resonators 100 can be solid or hollow. In one or more embodiments, a first group 131 of the resonators 100 is solid and a second group 132 of the resonators 100 is hollow. When the resonators 100 are hollow, the resonators can be filled with a gas (e.g., air). The gas can be introduced before or after the system 10 and/or the support body 110 is/are deployed. In one or more embodiments, each resonator 100 can be hollow and can include a respective cavity 104 to retain a gas. In one or more embodiments, one or more fluid lines 142 can be fluidly coupled to the resonators 100 to introduce the gas into the cavities 104. The gas can be supplied from a gas tank 140. Only one fluid line 142 is shown in FIG. 1 for illustration purposes only. In one or more embodiments, the system 10 includes a plurality of fluid lines 142 where each fluid line 142 is fluidly coupled to one or more respective cavities 104 or one or more respective resonators 100. In one or more embodiments, each resonator 100 can include an opening such as at the tapered end 102 to trap gas as the noise-abatement system 10 is placed in the body of water 122.

In one example, the resonators 100 include or consist of a metal such as, but not limited to, aluminum, brass, and/or steel. In another example, the resonators 100 include or consist of a plastic or a polymer such as, but not limited to, high density polypropylene, polycarbonate, and/or nylon. In some embodiments, a first group 131 of resonators 100 can include or consist of a first material and a second group 132 of resonators 100 can include or consist of a second material (e.g., different than the first material). The resonators 100 can be configured to resonate at one or more target frequencies. For example, a first group 131 of resonators 100 can be configured to resonate at a first frequency and a second group 132 of resonators 100 can be configured to resonate at a second frequency.

The support body 110 can include a solid structure, as illustrated, or another structure. The support body 110 is shown as a cylinder (or more generally, a prism) with a central hole 114 to form a hollow cylinder. The support body 110 has a first (or outer) radius 151 and a height 154 where the first radius 151 is larger (e.g., significantly larger) than the height 154. For example, the first radius 151 can be 10 to 100 times larger than the height 154, such that the support body 110 is squat and resembles a disk. The first radius 151 and the height 154 can be measured with respect to respective axes that are mutually orthogonal. The first radius 151 can be measured from a central axis 116 of the support body 110, which is parallel to the axis used to measure the height 154 of the support body 110. In one or more alternatives, the support body 110 can have another shape such as a rectangular prism.

The central hole 114 is defined by a second (or inner) radius 152 of the support body 110. The central hole 114 is configured and/or sized to receive a monopile 160 that is mounted to and/or attached to the floor 120. In one or more embodiments, the central hole 114 is configured and/or sized to extend a predetermined radial distance from the external surface 162 of the monopile 160 to avoid contact with scour protection 170 for the monopile 160. Examples of scour protection can include large rocks, gravel, concrete blocks, and/or bags of material (e.g., sandbags and/or gravel bags). The monopile 160 is shown as a cylinder with a central axis that is collinear with the central axis 116 of the support body 110.

The bottom surface 112 is oriented downward towards the direction of gravitational pull 184. The bottom surface 112 can be planar and can be orthogonal to the central axis 116. The central axis 116 can be parallel to the direction of gravitational pull 184.

In one or more embodiments, the system 10 can include the monopile 160. In one or more embodiments, the system 10 can include the monopile 160 and the scour protection 170.

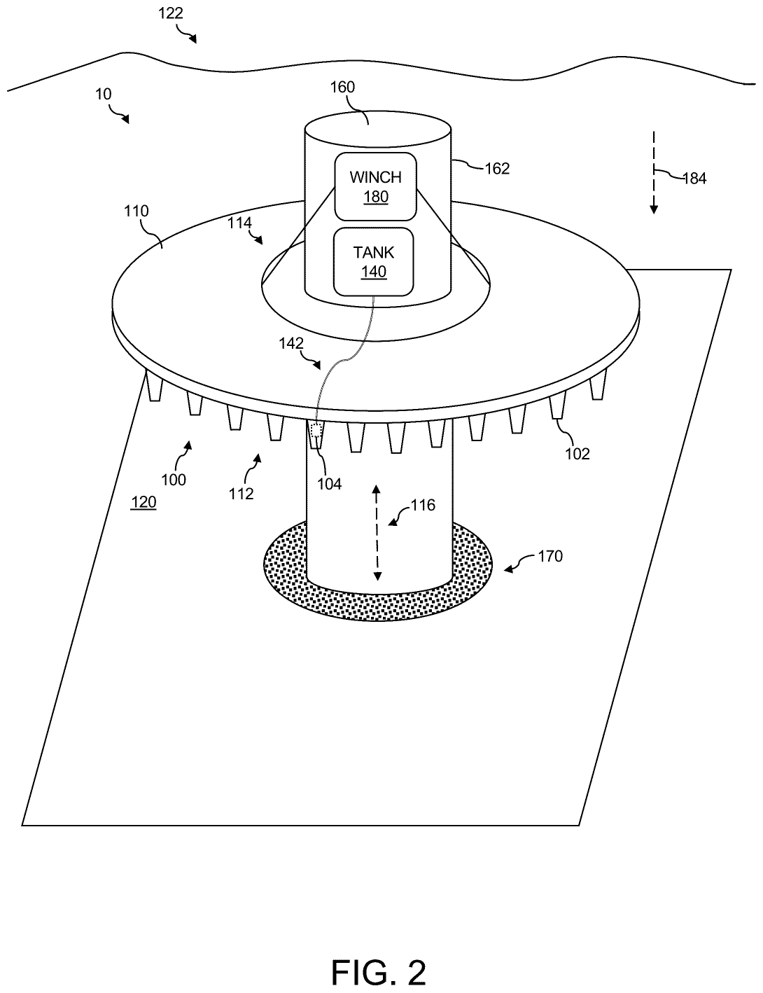

In one or more embodiments, the support body 110, including the resonators 100, can be raised and lowered using a winch 180 or another device. The winch 180 can be mechanically coupled to one or more tethers (e.g., chains, ropes, cables, and/or another tether) 182 that are attached to the base 110. The winch 180 can be used to transition the support body 110 between the stowed state (FIG. 1) and a retracted state, as shown in FIG. 2. The support body 110 is moved in an upward direction, parallel to the central axis 116 of the support body 110, in an opposite direction from the direction of gravitational pull 184, to transition the support body 110 from the deployed state (FIG. 1) to the retracted state (FIG. 2). The support body 110 is moved in a downward direction, parallel to the central axis 116 of the support body 110 and in the same direction as the direction of gravitational pull 184, to transition the support body 110 from the retracted state (FIG. 2) to the deployed state (FIG. 1).

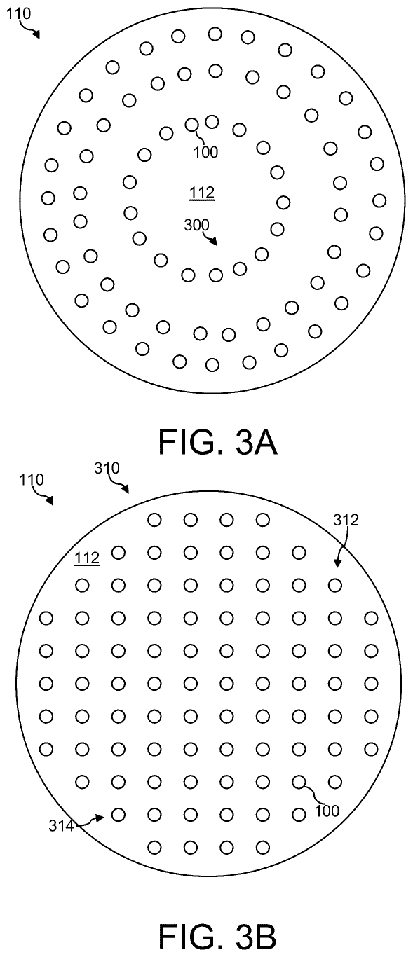

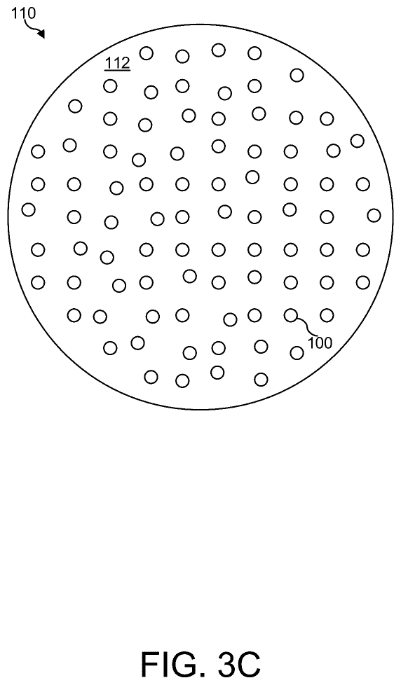

FIG. 3A is a bottom view of the support body 110 according to one or more embodiments. The resonators 100 are attached to the bottom surface 112 of the support body 110 in a plurality of concentric circles 300.

FIG. 3B is a bottom view of the support body 110 according to one or more alternative embodiments. The resonators 100 are attached to the bottom surface 112 of the support body 110 in a grid 310 having a plurality of columns 312 and rows 314.

FIG. 3C is a bottom view of the support body 110 according to one or more alternative embodiments. The resonators 100 are attached to the bottom surface 112 of the support body 110 in a random arrangement.

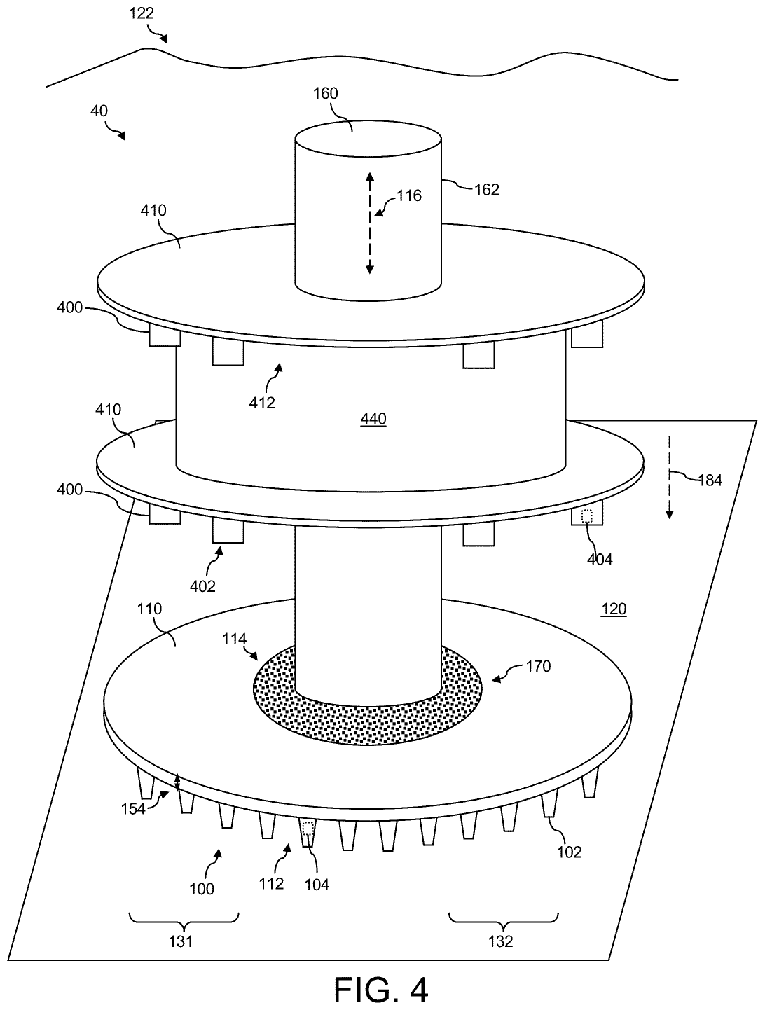

FIG. 4 is an isometric view of a noise-abatement system 40 for water and ground-borne noise according to one or more embodiments. The system 40 is the same as the system 10 except that system 40 includes one or more (e.g., a plurality of) additional support structures 410 that is/are attached to and/or mechanically coupled to a pile gripper or a pile template 440 that is attached to, mechanically coupled to, and/or disposed about or in close proximity to (e.g., within about 1 meter of, within about 2 meters of, within about 5 meters of, within about 10 meters of, within about 25 meters of, within about 50 meters of, within about 75 meters of, or within about 100 meters of, including any range or value between any two of the foregoing values) the monopile 160. Additionally or alternatively, one or more of the support structures 410 can be attached and/or mechanically coupled to another type of support structure (e.g., that can be directly or indirectly attached and/or mechanically coupled to the monopile 160 and/or to the pile gripper/template 440 or that can disposed in close proximity to (e.g., within about 1 meter of, within about 2 meters of, within about 5 meters of, within about 10 meters of, within about 25 meters of, within about 50 meters of, within about 75 meters of, or within about 100 meters of, including any range or value between any two of the foregoing values) the monopile 160). A plurality of resonators 400 are attached to a respective bottom surface 412 of the/each support structure 410. Each bottom surface 412 can be planar and can be oriented towards the direction of gravitational pull 184. A plane of the bottom surface 412 can be orthogonal to the central axis 116 of the monopile 160.

The resonators 400 are configured for water-borne noise basement. For example, the resonators 400 can include open ends 402 that are configured to trap and/or retain water in respective cavities 404 of the resonators 400. Gas, such as air, can be entrapped and/or retained in the cavities 404 when the resonators 400 are deployed in the body of water 122. Alternatively, the cavities 404 can be filled with a gas, such as air, from a gas tank or gas supply. The resonators 400 can be the same as those described in U.S. Pat. No. 9,410,403, titled “Underwater Noise Reduction System Using Open-Ended Resonator Assembly And Deployment Apparatus,” issued Aug. 9, 2016 and/or in U.S. Pat. No. 11,812,221, titled “System And Method For Simultaneously Attenuating High-Frequency Sounds And Amplifying Low-Frequency Sounds Produced By Underwater Acoustic Pressure Source,” issued Nov. 7, 2023, which are hereby incorporated by reference.

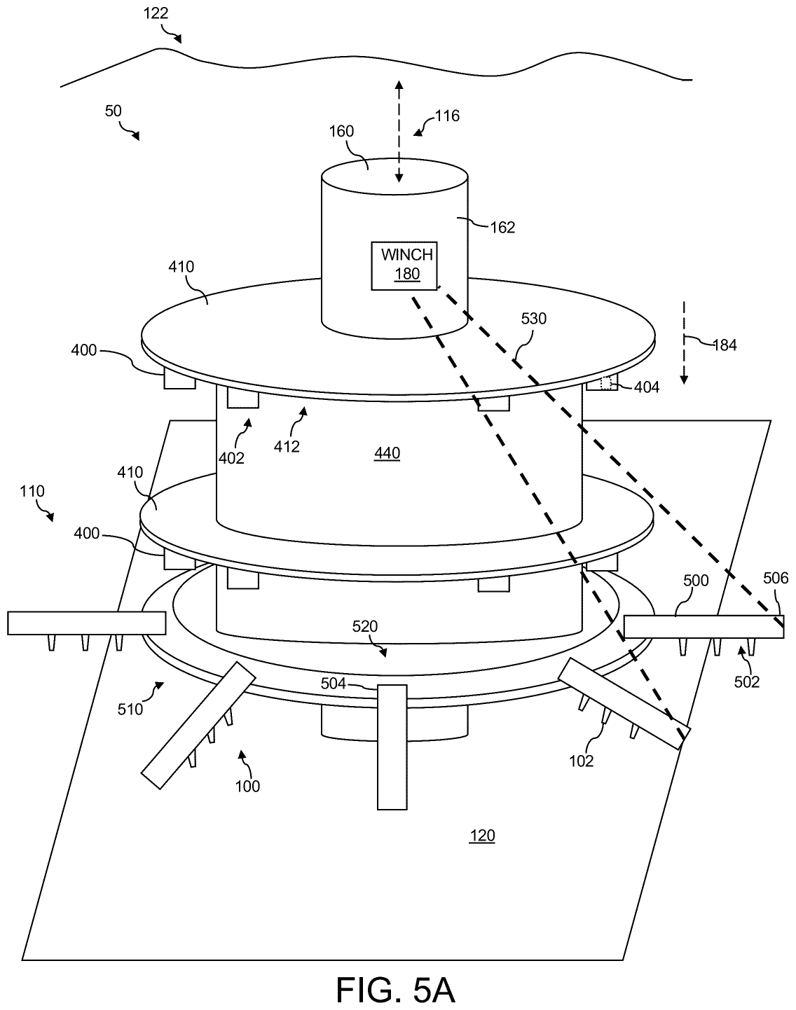

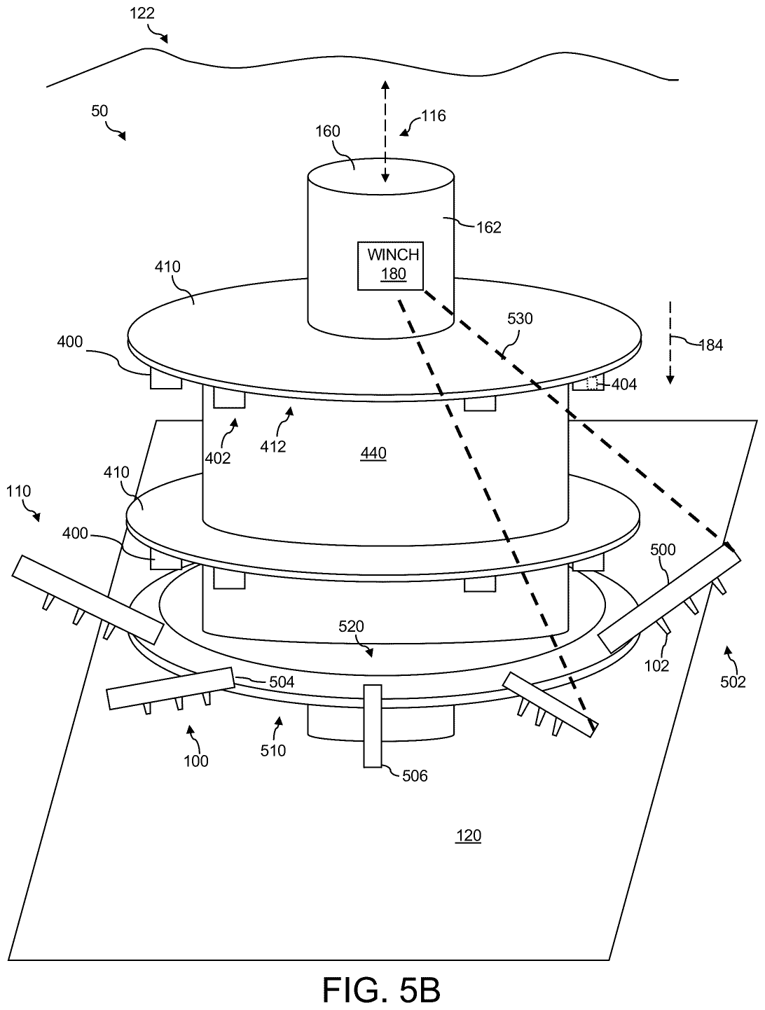

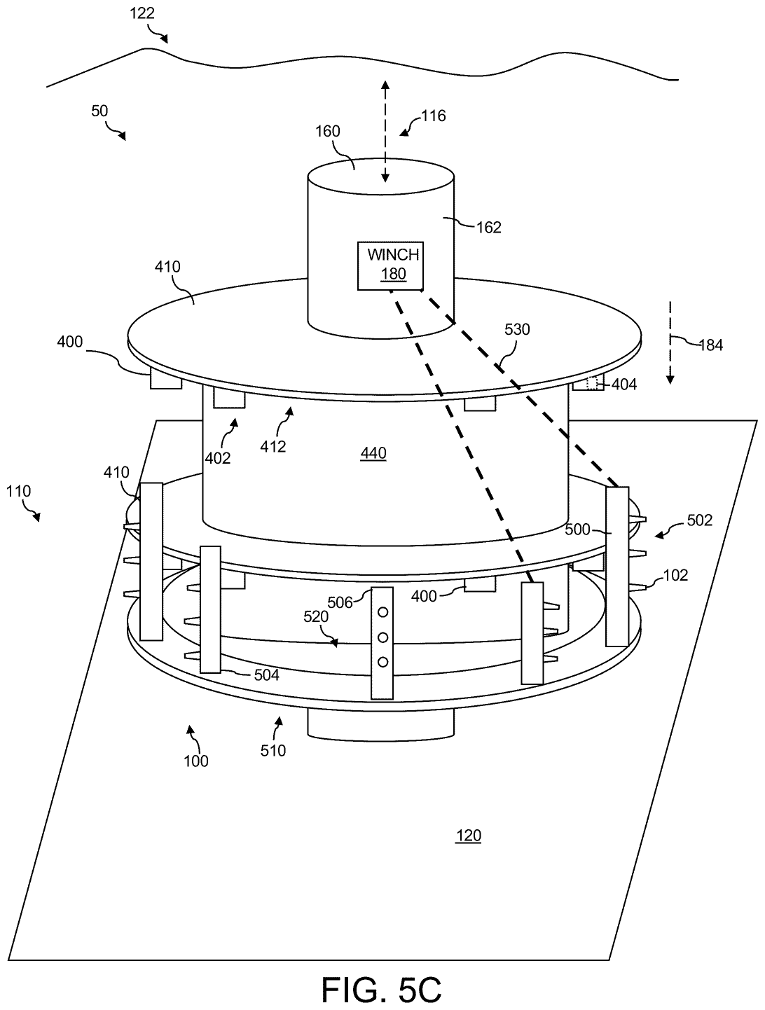

FIG. 5A is an isometric view of a noise abatement system 50 for water and ground-borne noise according to one or more alternative embodiments. System 50 is the same as system 40 except that in system 50 the support structure 110 includes a plurality of arms 500. A bottom surface 502 of each arm 500 is attached to a respective plurality of resonators 100. A first end 504 of each arm 500 is attached (e.g., pivotably attached) to a common support structure 510, which is attached to and/or mechanically coupled to a pile gripper/template 440. Additionally or alternatively, each arm 500 can be attached and/or mechanically coupled to another type of support structure (e.g., that can be directly or indirectly attached and/or mechanically coupled to the monopile 160 and/or to the pile gripper/template 440 or that can disposed in close proximity to (e.g., within about 1 meter of, within about 2 meters of, within about 5 meters of, within about 10 meters of, within about 25 meters of, within about 50 meters of, within about 75 meters of, or within about 100 meters of, including any range or value between any two of the foregoing values) the monopile 160). The bottom surface 502 of each arm 500 is oriented downward towards the floor 120 and towards the direction of gravitational pull 184. The common support structure 510 can be a ring (e.g., a hollow cylinder) that forms a gap 520 between the common support structure 510 and the monopile 160 (e.g., up to a predetermined radial distance) to provide space for scour protection.

Additional resonators 400 configured for water-borne noise abatement can also be attached, directly or indirectly, to a support structure as described above. For example, the additional resonators 400 can be attached to and/or mechanically coupled to one or more additional support structures 410 that is/are attached to and/or mechanically coupled to a pile gripper or a pile template.

The system 50 is shown in a deployed state in FIG. 5A. To transition to a retracted state, the arms 500 can be raised or pivoted upwards towards the monopile 160, for example using tethers (e.g., chains, ropes, cables, and/or another tether) 530 which can be pulled by one or more motors or winches 180. The tethers 530 can be attached to or near a second end 506 of each arm 500. Only two tethers 530 are shown in FIG. 5A for illustration purposes only. In other embodiments, the tethers 530 can be attached to only some of the arms 500 and some of the arms 500 can be mechanically coupled so that they can be raised or lowered together.

The arms 500 are in a partially deployed/stowed state in FIG. 5B and in a retracted or stowed state in FIG. 5C. When the system 50 is in the deployed state (FIG. 5A), the second end 506 of each arm 500 is further away from the monopile 160 than when the system 50 is in the retracted state (FIG. 5C). In contrast, when the system 50 is in the retracted state (FIG. 5C), the second end 506 of each arm 500 is closer to the monopile 160 than when the system 50 is in the deployed state (FIG. 5A).

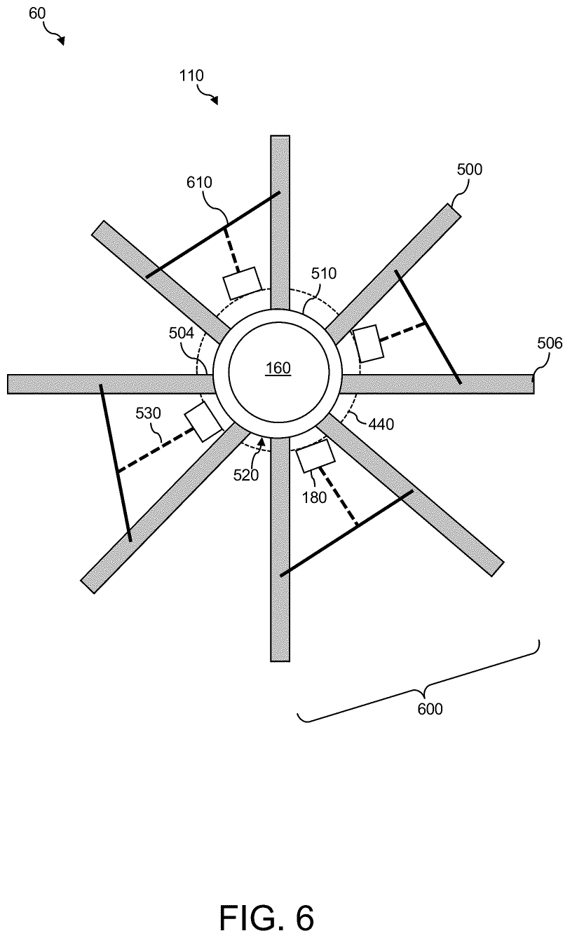

FIG. 6 is a top view of a noise abatement system 60 for water- and ground-borne noise according to one or more alternative embodiments. System 60 is the same as system 50 except that in system 60 the arms 500 are divided into pairs 600 of neighboring arms 500. Each pair 600 of neighboring arms 500 is mechanically coupled together with a respective crossbeam 610. A tether 530 can be attached to each crossbeam 610 to raise or lower the pair 600 of neighboring arms 500 together. Additionally or alternatively, a tether 530 can be attached to one of the arms 500 in each pair 600.

The tethers 530 are attached to one or more motors or winches 180 that is/are mechanically coupled and/or attached to a pile gripper/template 440. Additionally or alternatively, one or more motors or winches 180 (e.g., one, some, or all motors/winches 180) can be attached and/or mechanically coupled to another type of support structure (e.g., that can be directly or directly attached and/or mechanically coupled to the monopile 160 and/or to the pile gripper/template 440).

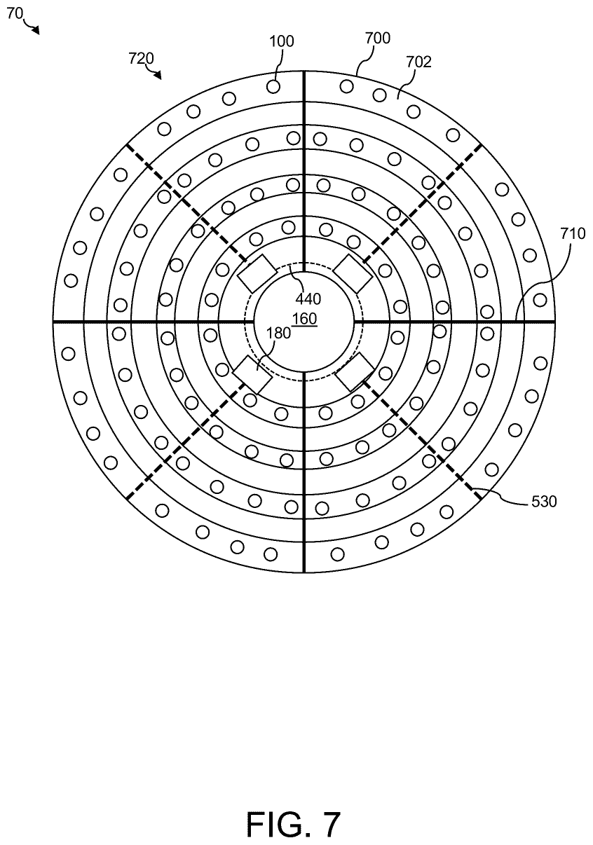

FIG. 7 is a bottom view of a noise abatement system 70 for water- and ground-borne noise according to one or more alternative embodiments. System 70 is the same as system 40 and/or system 10 except that in system 70 the support structure 110 includes a plurality of concentric rings 700. Each ring 700 can be formed of a respective hollow cylinder.

The resonators 100 are attached to the bottom surface 702 of the rings 700. The rings 700 can be mechanically coupled to one another, for example using one or more crossbeams 710, to allow the rings 700 to be raised and lowered together. The crossbeams 710 and/or the rings 700 can be attached to one or more tethers 530 to raise and lower the rings 700 using one or more motors or winches 180 that is/are mechanically attached to a pile gripper/template 440. Additionally or alternatively, one or more motors or winches 180 (e.g., one, some, or all motors/winches 180) can be attached and/or mechanically coupled to another type of support structure (e.g., that can be directly or indirectly attached and/or mechanically coupled to the monopile 160 and/or to the pile gripper/template 440 or that can disposed in close proximity to (e.g., within about 1 meter of, within about 2 meters of, within about 5 meters of, within about 10 meters of, within about 25 meters of, within about 50 meters of, within about 75 meters of, or within about 100 meters of, including any range or value between any two of the foregoing values) the monopile 160).

In one or more alternative embodiments, each ring 700 can be subdivided into a plurality of segments 720 where each segment can be raised or lowered separately. Two or more segments 720 can be mechanically coupled together, such as with a crossbar, to raise and lower the segments 720 together.

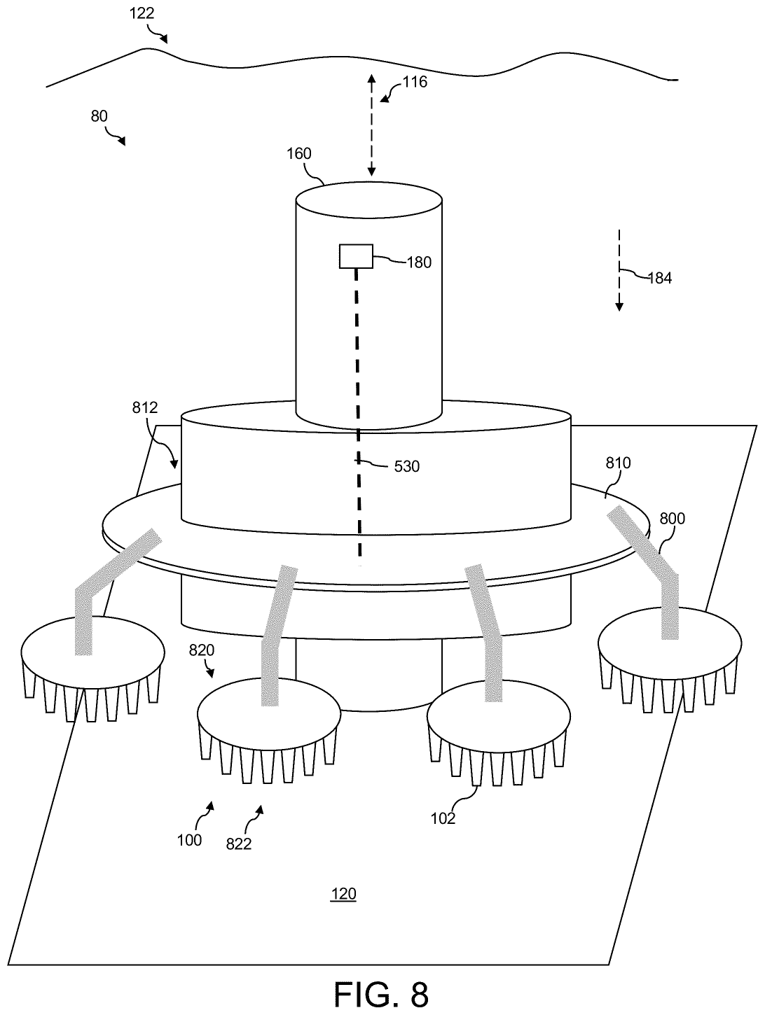

FIG. 8 is an isometric view of a noise abatement system 80 for ground-borne noise according to one or more alternative embodiments. A plurality of support arms 800 are attached to a common support structure 810, which has a hole 812 to receive a support structure such as a pile gripper/template 440. The common support structure 810 can be in the form of a ring (e.g., a hollow cylinder) or another shape and can be mechanically coupled to and/or attached to a pile gripper/template 440. Additionally or alternatively, each arm 800 can be attached and/or mechanically coupled to another type of support structure (e.g., that can be directly or indirectly attached and/or mechanically coupled to the monopile 160 and/or to the pile gripper/template 440 or that can disposed in close proximity to (e.g., within about 1 meter of, within about 2 meters of, within about 5 meters of, within about 10 meters of, within about 25 meters of, within about 50 meters of, within about 75 meters of, or within about 100 meters of, including any range or value between any two of the foregoing values) the monopile 160).

A resonator support body 820 is attached to the end of each support arm 800. A plurality of resonators 100 are attached to the bottom surface 822 of each resonator support body 820. The resonator support bodies 820 are shown as circular. In other embodiments, the resonator support bodies 820 can be other shapes such as ovals, rectangles, and/or other shape(s). One or more tethers (e.g., chains, ropes, cables, and/or another tether) 530 can be attached to the common support structure 810 to raise or lower the common support structure 810, the support arms 800, the resonator support bodies 820, and the resonators 100, for example using one or more motors or winches 180 that is/are mechanically attached to a support structure such as a pile gripper/template 440.

The bottom surface 822 of each support body 820 is oriented downwards towards the direction of gravitational pull 184.

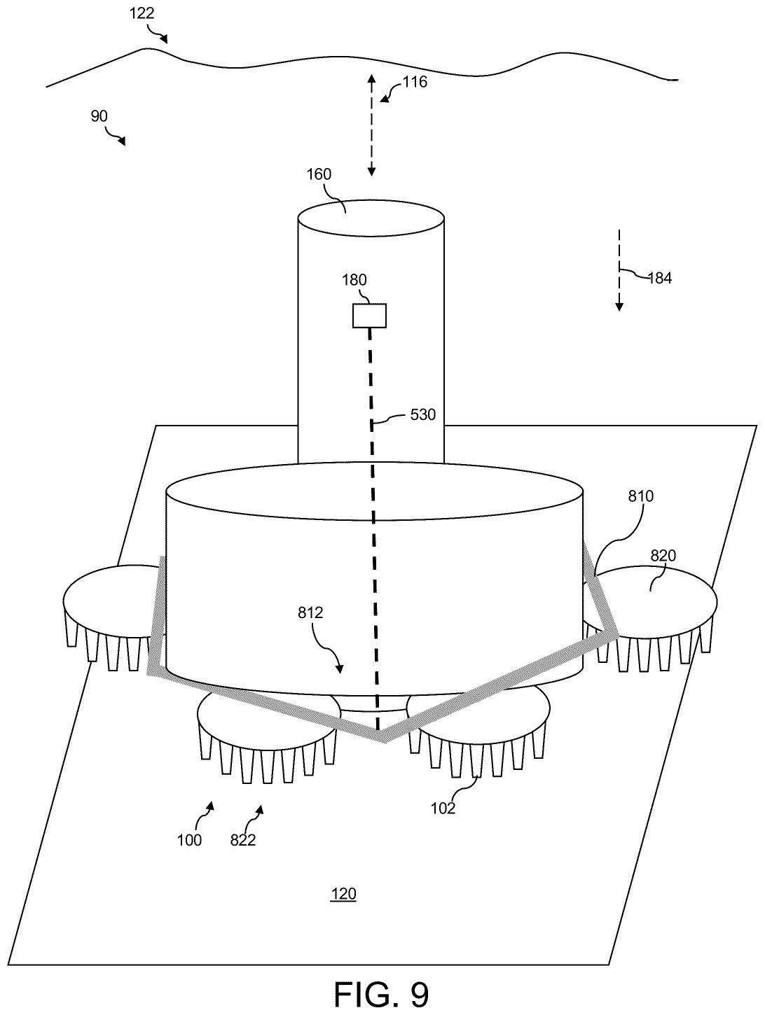

FIG. 9 is an isometric view of a noise abatement system 90 for ground-borne noise according to one or more alternative embodiments. System 90 is the same as system 80 except that system 90 does not include the support arms 800 in system 80. Instead, the resonator support bodies 820 are attached to a common support structure 810 that is attached to a support structure such as a pile gripper/template 440. The common support structure 810 is shown as a pentagon (e.g., a pentagon prism) having a hole 812 to receive the pile gripper/template 440. The common support structure 810 can be another shape such as a ring, an oval, a rectangle, or another shape in one or more alternative embodiments. One or more tethers 530 can be attached to the common support structure 810 to raise or lower the common support structure 810, the resonator support bodies 820, and the resonators 100 using one or more motors or winches 180 that is/are mechanically attached to the monopile 160. Alternatively, the one or more motors or winches 180 can be mechanically attached to a support structure such as the pile gripper/template 440.

The bottom surface 822 of each support body 820 is oriented downwards towards the direction of gravitational pull 184.

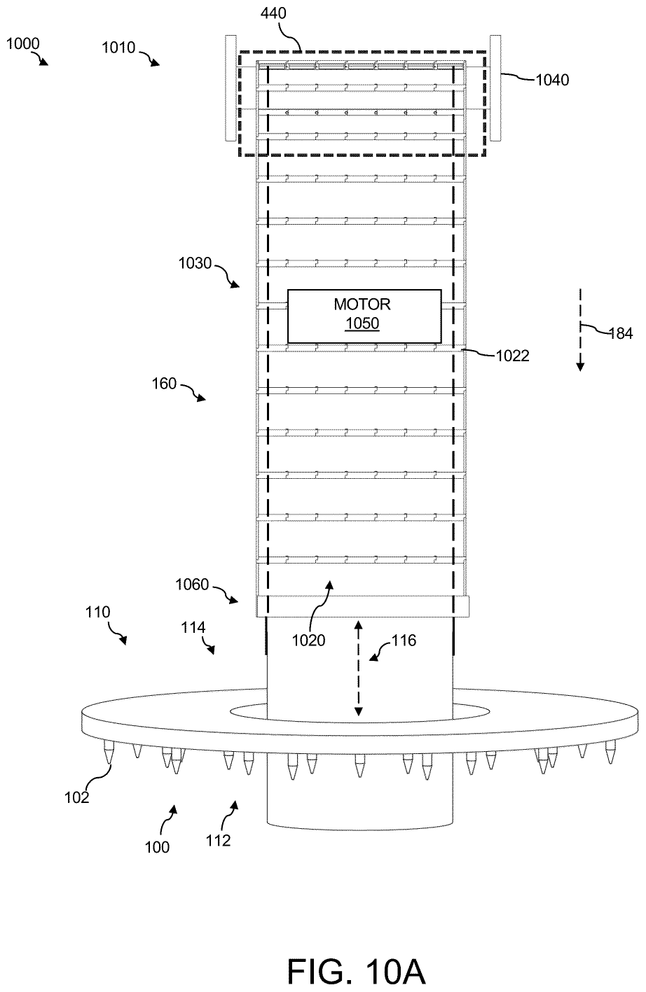

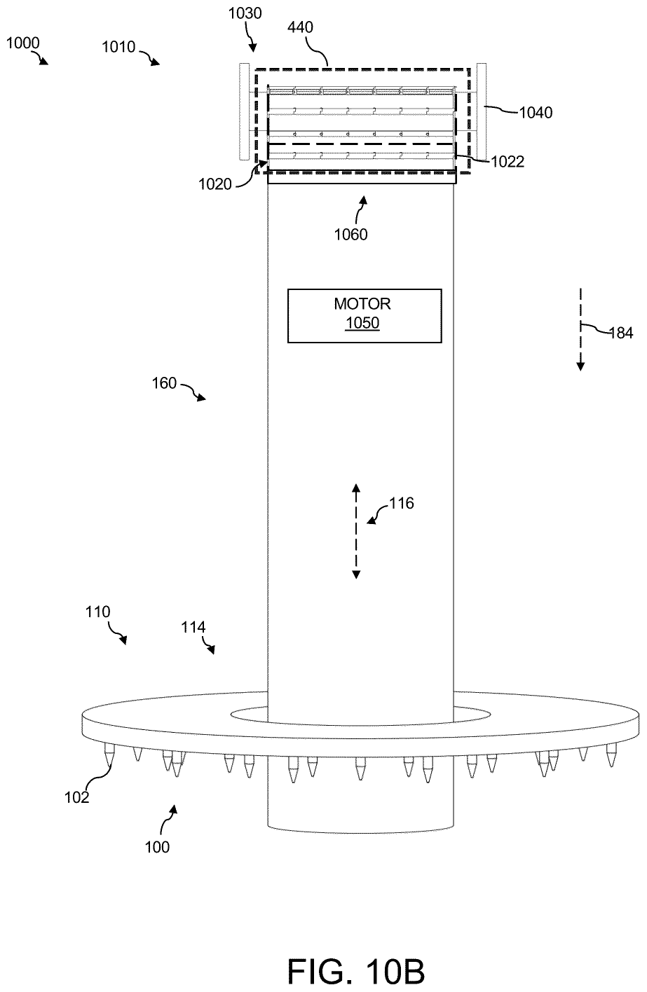

FIG. 10A is an isometric view of a noise abatement system 1000 for water- and ground-borne noise according to one or more alternative embodiments. System 1000 is the same as system 40 except that system 1000 includes a spooled resonator assembly 1010 instead of the additional support structure(s) 410. In one or more embodiments, the noise abatement system 1000 can include both the spooled resonator assembly 1010 and the additional support structure(s) 410 including the additional resonators 400 (FIG. 4). The spooled resonator assembly 1010 includes a plurality of elongated resonator blocks 1020. The resonator blocks 1020 can be attached to each other to form a resonator row 1022. Alternatively, a resonator block 1020 can be long enough to form a resonator row 1022. The resonator rows 1022 are attached and/or mechanically coupled to one or more tethers (e.g., chains, ropes, cables, and/or another tether) 1030. The tethers 1030 are attached to a spool 1040 that is mounted on and/or attached to a support structure such as a pile gripper/template 440.

The spooled resonator assembly 1010 is shown in a deployed state. To transition from the deployed state to a stowed state, the spool 1040 rotates in a first direction to wind the tethers 1030 and the resonator blocks 1020 around the spool 1040, as shown in FIG. 10B. To transition from the stowed state to the deployed state, the spool 1040 rotates in a second direction, opposite to the first direction, to release the tethers 1030 and the resonator blocks 1020 from the spool 1040. A motor or winch 1050 can be mechanically coupled to the spool 1040 to rotate the spool 1040 in the first or second direction depending on the state of the motor. In one or more embodiments, a weight 1060 can be attached to the bottom of the tethers 1030 to provide tension in the tethers 1030 while the spooled resonator assembly 1010 is in the deployed state and/or to cause the tethers 1030 and the resonator blocks 1020 to deploy from the stowed state. The spool 1040 can include or can be coupled to a winch to transition the spooled resonator assembly 1010 between the deployed state and the stowed state. In some embodiments, the spooled resonator assembly 1010 can be placed on ship and deployed adjacent to a monopile or other target from the ship.

In some embodiments, the system 1000 includes a plurality of spooled resonator assemblies 1010 to deploy resonator blocks 1020 on multiple sides of the monopile 160.

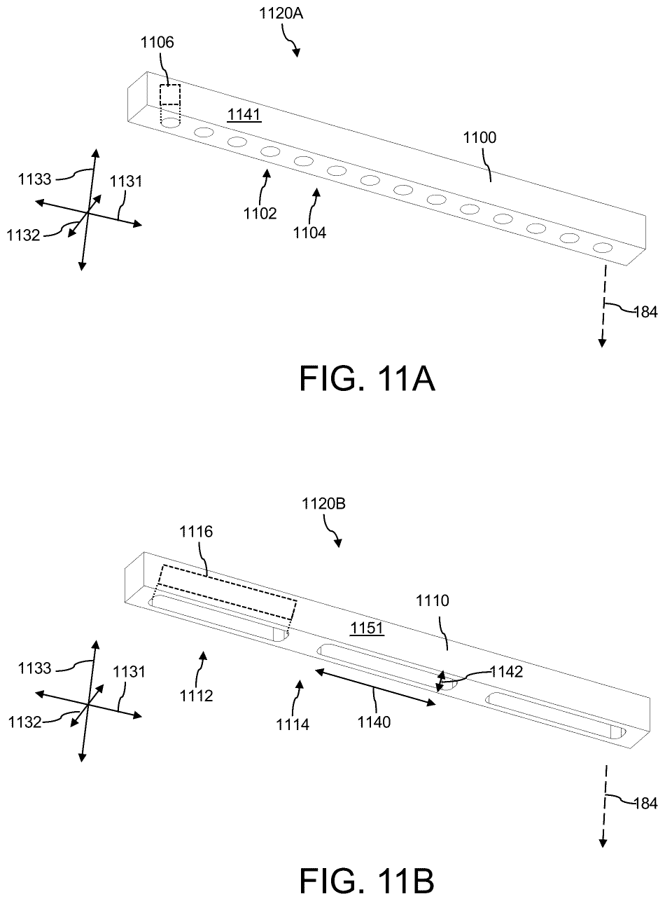

FIGS. 11A and 11B are isometric views of resonators blocks 1120A, 1120B according to one or more alternative embodiments. Each resonators block 1120A, 1120B can be the same as a resonator block 1020 (FIG. 10) and/or the same as a resonator 400.

Resonator block 1120A includes an elongated body 1100 in the form of a rectangular prism or another shape. A plurality of holes 1102 are defined in a surface or face (e.g., a bottom surface 1104) of the body 1100. The holes 1102 are fluidly coupled to respective internal resonator cavities 1106 (only one cavity 1106 is shown for illustration purposes only) to form a multi-resonator strip. In one or more embodiments, two or more holes 1102 can be fluidly coupled to the same cavity 1106. In one or more embodiments, all holes 1102 can be fluidly coupled to the same cavity 1106. In one or more embodiments, the holes 1102 can be grouped where each group is fluidly coupled to a respective cavity 1106. The holes 1102 are circular but can be square, rectangular, or another shape.

Each hole 1102 and/or each cavity 1106 can be the same shape or a different shape than one or more other holes 1102 and/or one or more other cavities 1106, respectively. Additionally or alternatively, each hole 1102 and/or each cavity 1106 can be the same size or a different size than the one or more other holes 1102 and/or one or more other cavities 1106, respectively.

The holes 1102 are spaced along the length of the resonator block 1120A, which is measured along or with respect to a first axis 1131. The bottom surface 1104 is parallel to a plane formed by the first axis 1131 and a second axis 1132 that is orthogonal to the first axis 1131. The first and second axes 1131, 1132 are orthogonal to a third axis 1133 that is parallel to the direction of gravitational pull 184. The holes 1102 can be formed, machined, cut, drilled, deep drawn, molded, and/or or extruded into the body 1100. In one or more embodiments, the holes 1102 and/or the cavities 1106 can have square or rectangular profiles or profiles that are rounded or contoured at one or more ends, or other profiles and form factors.

The resonator body 1100 is generally solid and has solid surfaces/faces 1141 except for the holes 1102 defined in the bottom surface 1104 and the internal cavity(ies) 1106. In use, when deployed in a liquid (e.g., water) environment, the resonator block 1120A is positioned as shown with its bottom surface 1104 facing downward (towards the direction of gravitational pull 184) so that the cavity(ies) 1106 can be fully or partially filled with or hold a quantity of gas (e.g., air). The gas can be introduced before or after the resonator block 1120A is deployed. In an example, one or more fluid lines can be placed beneath or may be fluidly coupled to the resonator block 1120A to introduce the gas which is forced upward by the force of buoyancy into the resonator cavity(ies) 1106. The gas can be supplied from a gas tank or a compressor receiving air from above the surface of the water in which the resonator block 1120A is placed. External acoustic energy incident on the resonator block 1120A and its walls and gas in cavity 1106 causes energetic transfer (typically as dissipated heat and/or molecular vibration) to diminish the acoustic energy (noise) available for transmission to the general environment around and beyond resonator block 1120A. Those skilled in the art will appreciate that systems of such resonator blocks 1120A, having a plurality of tens, hundreds, thousands, tens of thousands, hundreds of thousands, or more of such resonator blocks 1120A can be configured and deployed at or around an underwater noise source to reduce the acoustic energy and noise impact on the underwater environment (e.g., a channel, lake, ocean). For example, the cavities 1106 act individually and/or collectively with other gas resonator volumes to diminish environmental noise energy interacting with the resonator block 1120A.

Resonator block 1120B includes an elongated body 1110 in the form of a rectangular prism or another shape. A plurality of elongated holes 1112 are defined in a surface or face (e.g., a bottom surface 1114) of the body 1110. The holes 1112 are fluidly coupled to respective internal resonator cavities 1116 (only one cavity 1116 is shown for illustration purposes only) to form a multi-resonator strip. In one or more embodiments, two or more holes 1112 can be fluidly coupled to the same cavity 1116. In one or more embodiments, all holes 1112 can be fluidly coupled to the same cavity 1116. The holes 1112 are elongated with respect to the first axis 1131 and are spaced along the length of the resonator block 1120B, which is measured along or with respect to a first axis 1131. The bottom surface 1114 is parallel to a plane formed by the first axis 1131 and a second axis 1132 that is orthogonal to the first axis 1131. The first and second axes 1131, 1132 are orthogonal to a third axis 1133 that is parallel to the direction of gravitational pull 184.

The holes 1112 have a length 1140, as measured with respect to the first axis 1131, that is larger than a width 1142, as measured with respect to the second axis 1132. In one or more embodiments, the length 1140 is about 2 times to about 10 times larger than the width 1142, including about 4 times larger, about 6 times larger, 8 times larger, and any value or range between any two of the foregoing values. As used herein, “about” means plus or minus 10% of the relevant value. In one or more embodiments, the length 1140 is about 2 times to about 100 times larger than the width 1142, including about 10 times larger, about 20 times larger, 30 times larger, about 40 times larger, 50 times larger, about 60 times larger, 70 times, about 80 times larger, 90 times larger, larger, and any value or range between any two of the foregoing values. The holes 1112 can comprise and/or resemble slots. The holes 1112 can be formed, machined, cut, drilled, deep drawn, molded, and/or or extruded into the body 1110. In one or more embodiments, the holes 1112 and/or the cavities 1116 can have square or rectangular profiles or profiles that are rounded or contoured at one or more ends, or other profiles and form factors.

Each hole 1112 and/or each cavity 1116 can be the same shape or a different shape than one or more other holes 1112 and/or one or more other cavities 1116, respectively. Additionally or alternatively, each hole 1112 and/or each cavity 1116 can be the same size or a different size than the one or more other holes 1112 and/or one or more other cavities 1116, respectively.

The bodies 1100, 1110 are elongated with respect to the first axis 1131. The bodies 1100, 1110 are shown as rectangular prisms but can be other shapes in one or more embodiments. In one example, the bodies 1100, 1110 include or consist of a metal. In another example, the bodies 1100, 1110 include or consist of a plastic, a polymer, wood, and/or other material. The resonator blocks 1120A, 1120B can be configured to resonate at one or more target frequencies at which they most effectively resonate and/or absorb sound energy.

The resonator body 1110 is generally solid and has solid surfaces/faces 1151 except for the holes 1112 defined in the bottom surface 1114 and the internal cavity(ies) 1116. In use, when deployed in a liquid (e.g., water) environment, the resonator block 1120B is positioned as shown with its bottom surface 1114 facing downward (towards the direction of gravitational pull 184) so that the cavity(ies) 1116 can be fully or partially filled with or hold a quantity of gas (e.g., air). The gas can be introduced before or after the resonator block 1120B is deployed. In an example, one or more fluid lines can be placed beneath or may be fluidly coupled to the resonator block 1120B to introduce the gas which is forced upward by the force of buoyancy into the resonator cavity(ies) 1116. The gas can be supplied from a gas tank or a compressor receiving air from above the surface of the water in which the resonator block 1120B is placed. External acoustic energy incident on the resonator block 1120B and its walls and gas in cavity 1116 causes energetic transfer (typically as dissipated heat, molecular vibration, and/or reradiation) to diminish the acoustic energy (noise) available for transmission to the general environment around and beyond resonator block 1120B. Those skilled in the art will appreciate that systems of such resonator blocks 1120B, having a plurality of tens, hundreds, thousands, tens of thousands, hundreds of thousands, or more of such resonator blocks 1120B can be configured and deployed at or around an underwater noise source to reduce the acoustic energy and noise impact on the underwater environment (e.g., a channel, lake, ocean). For example, the cavities 1116 act individually and/or collectively with other gas resonator volumes to diminish environmental noise energy interacting with the resonator block 1120B.

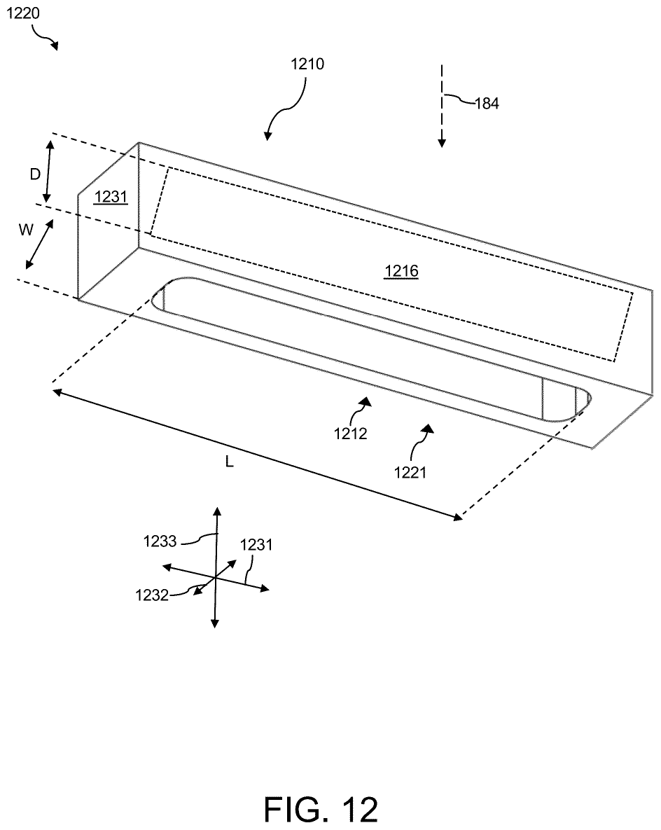

FIG. 12 is an isometric view of a slot resonator block 1220 according to one or embodiments. The slot resonator block 1220 can be the same as a resonator block 1020 (FIG. 10) and/or the same as a resonator 400.

The slot resonator block 1220 includes a solid elongated body 1210 into which an elongated hole 1212 is defined to form a cavity 1216 having a volume. The body 1210 and hole 1212 are elongated with respect to a first axis 1231. The internal volume of the cavity 1216 depends on several geometrical dimensions, including the cavity's length L, width W and depth D, which can be measured with respect to mutually orthogonal axes 1231-1233, respectively. In one example, the cavity 1216 may have a rectangular form factor. In that example, the internal volume may be equal to or approximately equal to V=L*W*D. The slot resonator block 1220 can comprise an elongated block (e.g., elongated with respect to axis 1231) of material that is machined, formed, extruded, molded and/or otherwise manufactured using a solid material (e.g., metal, polymer, resin, wood and/or other material) and which has substantially solid and closed faces 1231 except for the hole 1212 in one face (e.g., a bottom face) of the elongated body 1210. The hole 1212 and the volume of the cavity 1216 are suitable for accepting and holding an amount of gas therein, such as air. The cavity 1216 may be completely or partially filled with such gas during use.

In use, when deployed in a liquid (e.g., water) environment, the slot resonator block 1220 is positioned as shown with its open face 1221 downward (towards the direction of gravitational pull 184) so that the cavity 1216 can be fully or partially filled with or hold a quantity of gas (e.g., air). The gas can be introduced before or after the slot resonator block 1220 is deployed. In an example, one or more fluid lines can be placed beneath or may be fluidly coupled to the slot resonator block 1220 to introduce the gas which is forced upward by the force of buoyancy into the resonator cavity 1216. The gas can be supplied from a gas tank or a compressor receiving air from above the surface of the water in which the slot resonator block 1220 is placed. External acoustic energy incident on the slot resonator block 1220 and its walls and gas in cavity 1216 causes energetic transfer (typically as dissipated heat and/or molecular vibration) to diminish the acoustic energy (noise) available for transmission to the general environment around and beyond slot resonator block 1220. Those skilled in the art will appreciate that systems of such slot resonator blocks 1220, having a plurality of tens, hundreds, thousands, tens of thousands, hundreds of thousands, or more of such slot resonator blocks 1220 can be configured and deployed at or around an underwater noise source to reduce the acoustic energy and noise impact on the underwater environment (e.g., a channel, lake, ocean).

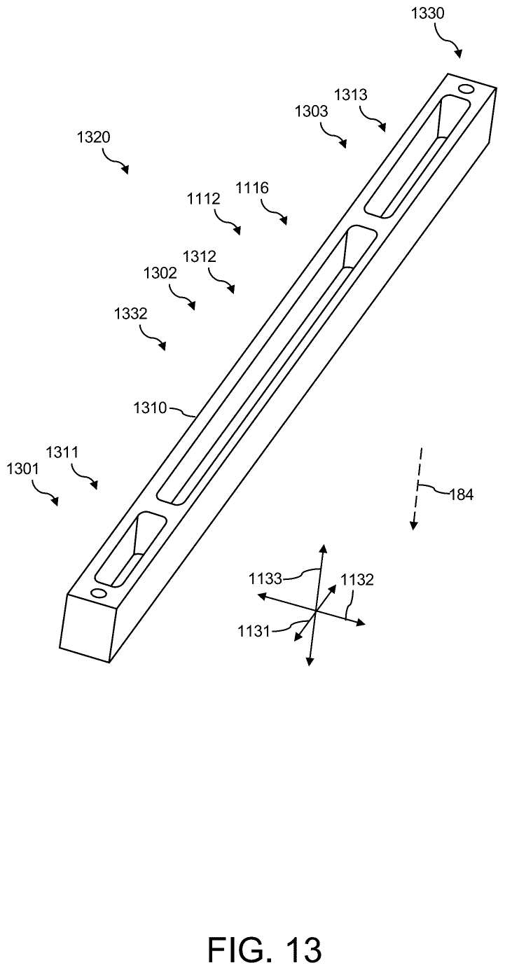

FIG. 13 is an isometric view of a slot resonator block 1320 according to one or more embodiments. The slot resonator block 1320 can be the same as a resonator block 1020 (FIG. 10) and/or the same as a resonator 400. The slot resonator block 1320 is the same as resonator block 1120B except that the holes 1112 and cavities 1116 in slot resonator block 1320 have different sizes. For example, the length of a first hole 1301 is smaller than the lengths of second and third holes 1302, 1303, respectively, as measured with respect to the first axis 1131. The length of the second hole 1302 is larger than the length of the first hole 1301 and smaller than the length of the third hole 1303. The length of the third hole 1303 is larger than the lengths of the first and second holes 1301, 1302, respectively.

The respective volumes of the cavities 1116 formed by the respective holes 1301-1303 can correspond to the respective lengths of the holes 1301-1303. For example, the volume of a first cavity 1311 formed by the first hole 1301 is smaller than the volumes of second and third cavities 1312, 1313, respectively, formed by the second and third holes 1302, 1303, respectively. The volume of the second cavity 1312 is larger than the volume of the first cavity 1311 and smaller than the volume of the third cavity 1313. The volume of the third cavity 1313 is larger than the volumes of the first and second cavities 1311, 1312, respectively. The volume of each cavity 1311-1313 can be by changing one or more respective dimensions of a respective cavity 1311-1313 with respect to one or more respective axes 1131-1133. For example, some resonator cavities 1311-1313 can have different lengths (or widths or depths, generally) than others. That is, not every elongated slot resonator cavity has to have the same length/width ratio, length/depth ratio, and/or width/depth ratio as the others. Collectively, the goal of the system would be to optimally address the undesired acoustic noise in the aquatic environment, including in some cases the acoustic spectrum where sound waves of different composition and wavelength exist.

The arrangement and/or relative order of the holes 1301-1303 and respective cavities 1311-1313 can be varied in different embodiments. In the illustrated embodiment, the second hole 1302 and second cavity 1312 is between the first hole 1301 and first cavity 1311 and the third hole 1303 and third cavity 1313. In one or more alternative embodiments, the first hole 1301 and first cavity 1311 can be between the second hole 1302 and second cavity 1312 and the third hole 1303 and third cavity 1313. In one or more alternative embodiments, the third hole 1303 and third cavity 1313 can be between the first hole 1301 and first cavity 1311 and the second hole 1302 and second cavity 1312.

The walls 1310 define three closed surfaces for each resonator cavity 1301-1303 such that when the open face 1332 of the cavities 1301-1303 faces downward (towards the direction of gravitational pull 184), the cavities 1301-1303 can be fully or partially filled with or hold a quantity of gas (e.g., air), for example as described above with respect to resonator blocks 1120A, 1120B, and/or 1220. A plurality of holes 1330 can be formed through the walls 1310 on opposing first and second sides 1301, 1302 of the slot resonator block 1320, such as through one or more walls 1310, to allow water to flow through as the slot resonator block 1320 is submerged/deployed.

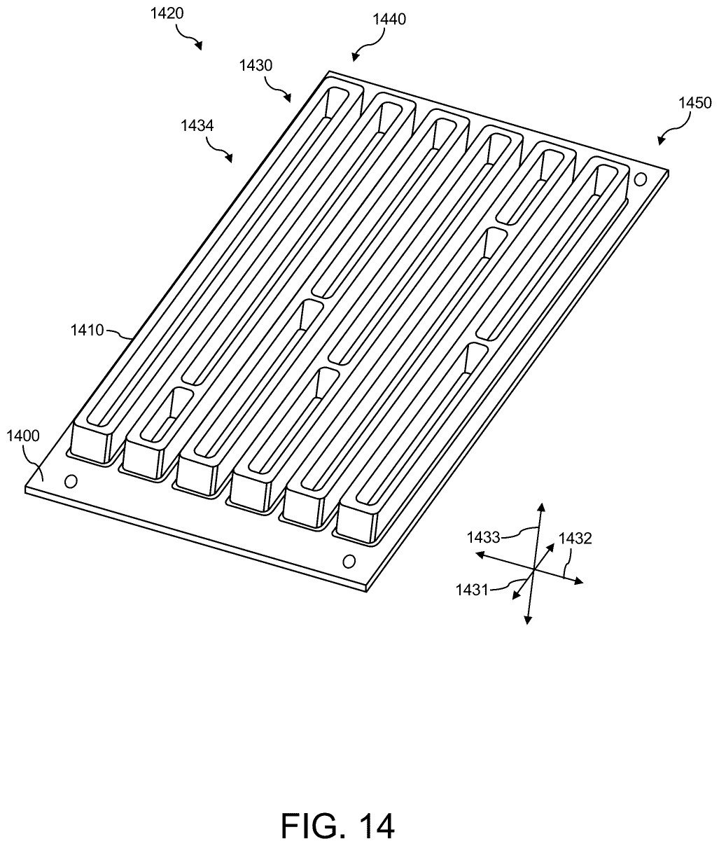

FIG. 14 is an isometric view of a slot resonator block 1420 according to one or more embodiments. The slot resonator block 1420 can be the same as a resonator block 1020 (FIG. 10) and/or the same as a resonator 400. The slot resonator block 1420 includes a base 1400 and a plurality of walls 1410 that extend from the base 1400. The walls 1410 define a plurality elongated slot resonator cavities 1430 to form a multi-resonator panel. The resonator cavities 1430 can be arranged parallel to each other and parallel to a first axis 1431. The length of a respective resonator cavity 1430, as measured with respect to the first axis 1431, is larger than the width of the respective resonator cavity 1430, as measured with respect to a second axis 1432. Each resonator cavity 1430 can have the same height, as measured with respect to a third axis 1433, or one or more resonator cavities 1430 can have a different height than one or more other resonator cavities 1420. The axes 1431-1433 are mutually orthogonal.

The walls 1410 and resonator cavities 1430 can form a plurality of rows 1440 on the base 1400 that are spatially distributed with respect to the second axis 1432. Each row 1440 includes at least one resonator cavity 1430. As shown, some rows 1440 can only include one resonator cavity 1430 while other rows can include two or more resonator cavities 1430. The lengths and number of the resonator cavities 1430 in the rows 1440 can vary to form a regular or random arrangement of resonator cavities 1430 on the base 1400. In one or more alternative embodiments, the lengths and number of the resonator cavities 1430 in the rows 1440 can be arranged in a pattern, such as a repeating pattern.

The walls 1410 and the base 1400 define three closed surfaces for each resonator cavity 1430 such that when the open face 1434 of the cavities 1430 faces downward (towards the direction of gravitational pull 184), the cavities 1430 can be fully or partially filled with or hold a quantity of gas (e.g., air), for example as described above with respect to resonator blocks 1120A, 1120B, and/or 1220. A plurality of holes 1450 can be formed through the base 1400 to allow water to flow through as the slot resonator block 1420 is submerged/deployed.

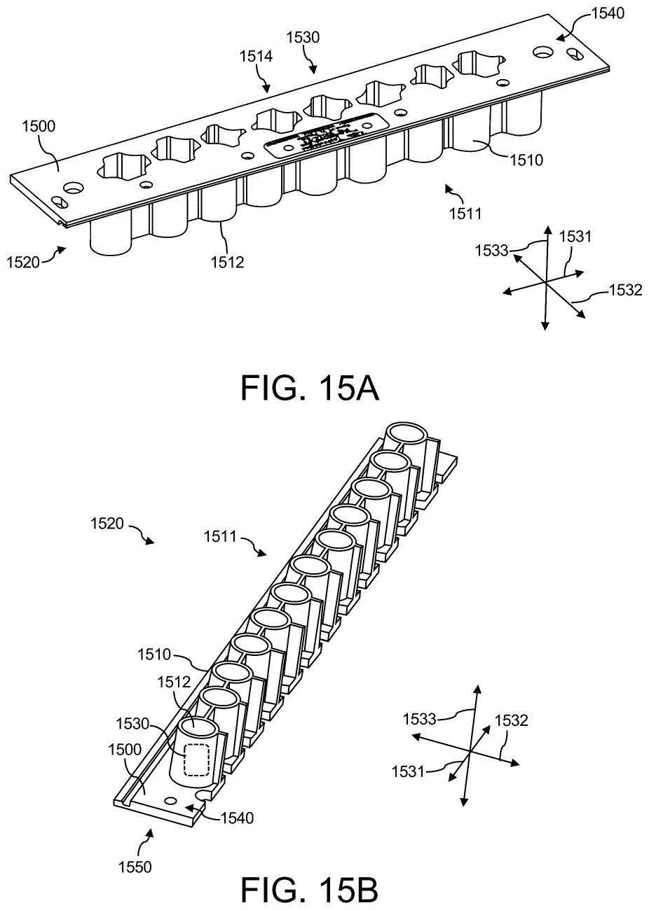

FIGS. 15A and 15B are isometric bottom and top views, respectively, of a resonator block 1520 according to one or more embodiments. The resonator block 1520 can be the same as a resonator block 1020 (FIG. 10) and/or the same as a resonator 400. The resonator block 1520 includes a base 1500 and a plurality of walls 1510 that extend from the base 1500. The walls 1510 form hollow resonator bodies 1511 that define respective resonator cavities 1530 to form a multi-resonator panel. The walls 1510 can form or define a tube having a closed end 1512 to define a respective volume of each resonator cavity 1530. A plurality of holes 1514 are defined in the base 1500 to expose each resonator cavity 1530.

The walls 1510 and resonator bodies 1511 are spaced apart from each other along or with respect to a first axis 1531. The spacing between each wall 1510 and resonator body 1511, as measured with respect to the first axis 1531, can be the same or can vary. Each tube, wall 1510 and/or resonator body 1511 has a respective height that can be measured with respect to a third axis 1533. Each tube, wall 1510 and/or resonator body 1511 has a respective diameter than be measured with respect to the first axis 1531 or with respect to a second axis 1532. Axes 1531-1533 are mutually orthogonal. The height and/or diameter of a tube, wall 1510 and/or resonator body 1511 can be the same or different than one or more other tubes, walls 1510 and/or resonator bodies 1511, respectively. The tubes, walls 1510 and/or resonator bodies 1511 can be arranged in a column or an array 1550. In one or more embodiments, one or more tubes, walls 1510 and/or resonator bodies 1511 in the column/array 1550 can be positionally offset on the base 1500 with respect to the second axis 1532.

In one or more embodiments, the height of the tubes, walls 1510 and/or resonator bodies 1511 can be larger than the height of the walls 1310 (FIG. 13) and/or the walls 1410 (FIG. 14). A plurality of holes 1540 can be formed through the base 1500 to allow water to flow through as the resonator block 1520 is submerged/deployed.

In one or more embodiments, one, some, or all walls 1510 can define another shape such as an oval prism and/or rectangular prism. In one or more embodiments, the diameter of the tubes, walls 1510 and/or resonator bodies 1511 can taper from the base 1500 to the closed end 1512 (or vice versa) such as in a cone or a frustum of a cone (e.g., a truncated cone).

When the open face (e.g., holes 1514) of the cavities 1530 faces downward (towards the direction of gravitational pull 184, the cavities 1530 can be fully or partially filled with or hold a quantity of gas (e.g., air), for example as described above with respect to resonator blocks 1120A, 1120B, and/or 1220.

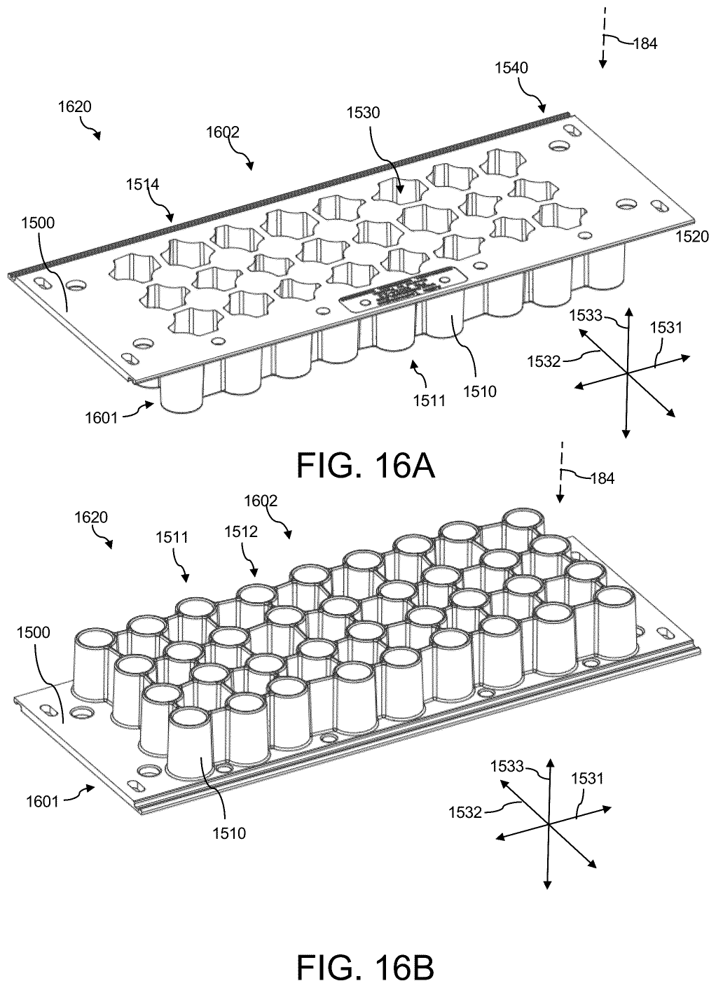

FIGS. 16A and 16B are isometric bottom and top views, respectively, of a resonator block 1620 according to one or more embodiments. The resonator block 1620 can be the same as a resonator block 1020 (FIG. 10) and/or the same as a resonator 400. The resonator block 1620 is the same as the resonator block 1520 except that the resonator block includes a plurality of rows 1601 and columns 1602 of walls 1510 (e.g., tubes having closed ends) and resonator cavities 1530. The rows 1601 are parallel to and/or generally parallel to the first axis 1531. The columns 1602 are parallel to and/or generally parallel to the second axis 1532.

The walls 1510 and resonator cavities 1530 can have regular and/or irregular spacing along with base 1500 with respect to the first axis 1531 and/or with respect to the second axis 1532. One or more walls 1510 in a given row 1601 can be spatially offset with respect to one or more other walls 1510 in that row 1601 with respect to the second axis 1532. Additionally or alternatively, one or more walls 1510 in a given column 1602 can be spatially offset with respect to one or more other walls 1510 in that column 1602 with respect to the first axis 1531.

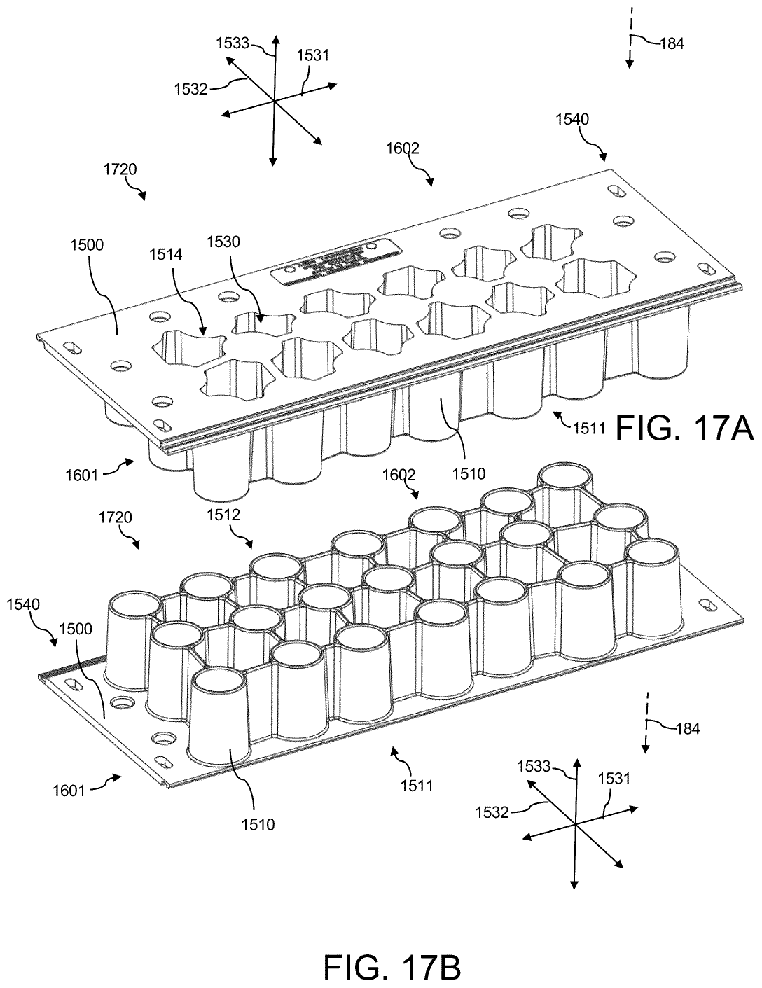

FIGS. 17A and 17B are isometric bottom and top views, respectively, of a resonator block 1720 according to one or more embodiments. The resonator block 1720 is the same as resonator block 1620 but with a different configuration and arrangement of the walls 1510 (e.g., tubes having closed ends) and resonator cavities 1530. The resonator block 1720 includes a fewer number of walls 1510 (e.g., tubes having closed ends) and resonator cavities 1530 than the resonator block 1620. The volume of the resonator cavities 1530 in resonator block 1720 can be larger than the volume of the resonator cavities 1530 in resonator block 1620.

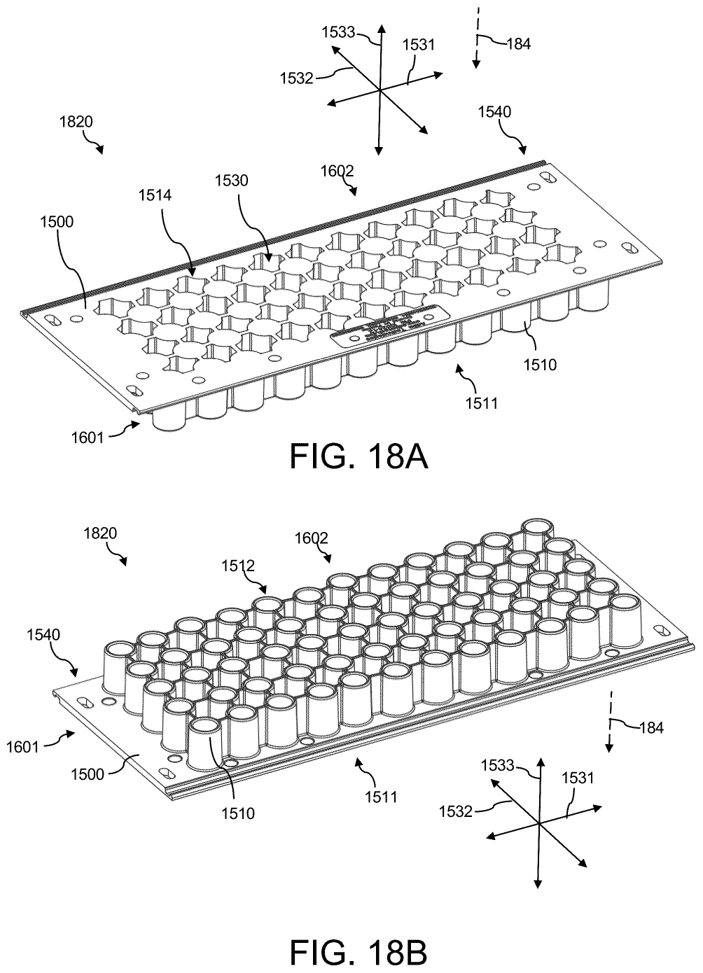

FIGS. 18A and 18B are isometric bottom and top views, respectively, of a resonator block 1820 according to one or more embodiments. The resonator block 1820 is the same as resonator block 1620, 1720 but with a different configuration and arrangement of the walls 1510 (e.g., tubes having closed ends) and resonator cavities 1530. The resonator block 1720 includes a greater number of walls 1510 (e.g., tubes having closed ends) and resonator cavities 1530 than the resonator blocks 1620, 1720. The volume of the resonator cavities 1530 in resonator block 1820 can be smaller than the volume of the resonator cavities 1530 in resonator blocks 1620, 1720.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A noise abatement system comprising:
a support body having a hole configured to receive a monopile; and
a plurality of resonators attached to a bottom surface of the support body, each resonator having a tapered tip that is configured to mechanically engage a floor of a body of water so as to acoustically couple a respective resonator and the floor of the body of water, the bottom surface oriented towards a direction of gravitational pull.

2. The noise abatement system of claim 1, wherein each resonator includes a respective cavity configured to retain a gas.

3. The noise abatement system of claim 2, further comprising:
a gas source; and
a plurality gas lines, each gas line fluidly coupled to the gas source and to the respective cavity(ies) of one or more of the resonators.

4. The noise abatement system of claim 1, wherein each resonator has a solid body.

5. The noise abatement system of claim 1, wherein the resonators are first resonators and the noise abatement system further comprises a plurality of second resonators mechanically coupled to a support structure, the support structure mechanically coupled to or disposed within about 100 meters of the monopile.

6. The noise abatement system of claim 5, further comprising:
a spool mechanically coupled to the support structure; and
one more tethers attached to the spool, the tether(s) mechanically coupled to the second resonators,
wherein the spool has a stowed state in which the tether(s) is/are wound around the spool and a deployed state in which the tether(s) is/are at least partially unwound from the spool.

7. The noise abatement system of claim 6, wherein the second resonators are formed in resonator blocks, the resonator blocks mechanically coupled to the tether(s).

8. The noise abatement system of claim 7, wherein each resonator block has a plurality of closed surfaces and a bottom surface in which one or more holes is/are defined, the hole(s) fluidly coupled to one or more resonator cavities defined in a body of a respective resonator block, each hole having a respective length, as measured with respect to a first axis, that is greater than a respective width, as measured with respect to a second axis, the bottom surface oriented orthogonally a third axis and towards the direction of gravitational pull, the first, second, and third axes mutually orthogonal.

9. The noise abatement system of claim 8, wherein the respective width is about 2 times to about 100 times greater than the respective width.

10. The noise abatement system of claim 7, wherein:
each resonator block has a base and a plurality of walls that extend from the base, the walls and the base comprising closed surfaces that define one or more resonator cavities, each resonator cavity having a respective open end disposed away from the base relative to a third axis, and
each resonator cavity has a respective length, as measured with respect to a first axis, that is greater than a respective width, as measured with respect to a second axis, the respective open end oriented orthogonally to the third axis and towards the direction of gravitational pull, the first, second, and third axes mutually orthogonal.

11. The noise abatement system of claim 10, wherein each resonator block defines a plurality of the resonator cavities, the resonator cavities arranged in one or more rows.

12. The noise abatement system of claim 11, wherein:
each resonator cavity has a respective volume, and
a volume of at least one of the resonator cavities is different than the volume of one or more other resonator cavities in a respective resonator block.

13. The noise abatement system of claim 7, wherein:
each resonator block has a base and a plurality of hollow resonator bodies that extend from the base,
each hollow resonator body has a respective closed end that is disposed away from the base relative to an axis, and
a plurality of holes are defined in the base, each hole spatially aligned with and fluidly coupled a respective resonator cavity, the respective hole oriented towards the direction of gravitational pull, the direction of gravitation pull parallel to the axis.

14. The noise abatement system of claim 13, wherein:
the axis is a first axis,
the resonator cavities form at least one row, each row extending parallel to a second axis,
at least some of the resonator cavities in a respective row are spatially offset from one or more other resonator cavities in the respective row with respect to a third axis, and
the first, second, and third axes are mutually orthogonal.

15. The noise abatement system of claim 14, wherein:
the resonator cavities form at least one column, each column extending parallel to the third axis, and
at least some of the resonator cavities in a respective column are spatially offset from one or more other resonator cavities in the respective column with respect to the second axis.

16. The noise abatement system of claim 1, wherein:
the support body comprises a plurality of concentric hollow cylinders that define rings, and
the noise abatement system further comprises:
a plurality of crossbars attached to the concentric hollow cylinders, each crossbar extending radially across the concentric hollow cylinders; and
a plurality of tethers, each tether mechanically coupled to one or more of the concentric hollow cylinders to raise and lower the concentric hollow cylinders.

17. A noise abatement system comprising:
a support body having a hole configured to receive a support structure, the support structure mechanically coupled to or disposed within about 100 meters of a monopile;
a plurality of arms, each arm having an end attached to the support body, each arm extending radially from the support body; and
a plurality of resonators attached to a bottom surface of each arm, each resonator having a tapered tip that is configured to mechanically engage a floor of a body of water so as to acoustically couple a respective resonator and the floor of the body of water, the bottom surface of each arm oriented towards a direction of gravitational pull.

18. The noise abatement system of claim 17, wherein:
the end is a first end,
the first end of each arm is pivotably attached to the support body such that the arms can transition from a stowed state in which a second end of each arm is closer to the monopile than when the arms are in a deployed state in which the second end of each arm is further from the monopile than when the arms are in the stowed state, and
the noise abatement system further comprises a plurality of tethers, each tether mechanically coupled to one or more of the arms to transition the one or more of the arms between the stowed and deployed states.

19. A noise abatement system comprising:
a common support body having a hole configured to receive a support structure, the support structure mechanically coupled to or disposed within about 100 meters of a monopile;
a plurality of resonator support bodies, each resonator support body mechanically coupled to the common support body; and
a plurality of resonators attached to a bottom surface of resonator support body, each resonator having a tapered tip that is configured to mechanically engage a floor of a body of water so as to acoustically couple a respective resonator and the floor of the body of water, the bottom surface oriented towards a direction of gravitational pull.

20. The noise abatement system of claim 19, further comprising a plurality of support arms, each support arm attached to the common support body and to a respective resonator support body.
